(19) United States
(12) Patent Application Publication
(10) Pub. No.: US 2018/0046559 A1
(43) Pub. Date: Feb. 15, 2018

(54) NON-TRANSITORY COMPUTER-READABLE STORAGE MEDIUM, FAILURE LOCATION SPECIFICATION APPARATUS, AND FAILURE LOCATION SPECIFICATION METHOD

(71) Applicant: FUJITSU LIMITED, Kawasaki-shi (JP)

(72) Inventor: Osamu SHIMOKUNI, Kawasaki (JP)

(73) Assignee: FUJITSU LIMITED, Kawasaki-shi (JP)

(21) Appl. No.: 15/651,229

(22) Filed: Jul. 17, 2017

(30) Foreign Application Priority Data
Aug. 10, 2016 (JP) 2016-158229

(51) Int. Cl. G06F 11/22; G06F 11/07

(52) U.S. Cl. CPC G06F 11/2289; G06F 11/0712; G06F 11/0778

(57) ABSTRACT

A failure location specification method executed including retrieving first setting information indicating a setting of a forward communication of a round trip between a first virtual machine and a second virtual machine, the forward communication being a communication from the first virtual machine to the second virtual machine, retrieving second setting information indicating a setting of a backward communication of the round trip, the backward communication being a communication from the second virtual machine to the first virtual machine in response to the forward communication, when the second setting information indicates that a communication between the first virtual machine and the second virtual machine is not established, retrieving third setting information and fourth setting information based on the first setting information, and specifying a failure location based on a pattern indicating a communication state and a plurality of reference patterns corresponding to each of a plurality of locations.

### CROSS-REFERENCE TO RELATED APPLICATION

This application is based upon and claims the benefit of priority of the prior Japanese Patent Application No. 2016-158229, filed on Aug. 10, 2016, the entire contents of which are incorporated herein by reference.

### FIELD

The embodiment discussed herein is related to a non-transitory computer-readable storage medium, a failure location specification apparatus, and a failure location specification method.

### BACKGROUND

In recent years, there has been a technique for specifying a failure occurrence location related to communication and analyzing the cause of a failure by using log information regarding the communication.

For example, a retrieval method has been proposed which is performed by a retrieval apparatus in a system in which a first apparatus group and a second apparatus group are connected to each other. In this retrieval method, a first history for specifying a communication source and a communication destination of communication performed between apparatuses in the first apparatus group and a second history for specifying a communication source and a communication destination of communication performed between apparatuses in the second apparatus group are acquired. A process of comparing the first history and the second history with each other and retrieving an apparatus in the first apparatus group and an apparatus in the second apparatus group which are apparatuses having the same function based on comparison results is performed.

In addition, a packet analysis system for efficiently detecting an incident, such as the generation of a new type of worm, has been proposed. In this system, retrieval results of log information acquired through a network are displayed, and a retrieval condition candidate list is also displayed, to thereby perform automatic setting of retrieval conditions by operating the retrieval condition candidate list and perform retrieval again.

In addition, for example, there has been a technique for setting a network for each transmission control protocol (TCP) session (unit for performing communication) through an overlay network in order to realize address translation or a load balancer for each TCP session. Since the TCP session is dynamically made whenever an application performs communication, the overlay network is also dynamically set in association therewith.

In the existing network technique, network setting is performed when a network is constructed in a hardware device, and thus examination regarding whether or not the network setting is normally performed may be performed during the construction of the network. However, in a case where network setting is dynamically performed as in the example of the above-mentioned overlay network, it is desirable to examine whether or not the network setting is normally performed whenever the network setting is performed.

Japanese Laid-open Patent Publication No. 2015-91049, Japanese Laid-open Patent Publication No. 2006-157355, and “MidoNet Reference Architecture 5.1-rev1”, 2016 Apr. 19, Midokura SARL are examples of the related art.

### SUMMARY

According to an aspect of the invention, a non-transitory computer-readable storage medium storing a failure location specification program that causes a computer to execute a process, the process including retrieving first setting information from a storage device based on identification information identifying each of communications through a network, the storage device storing pieces of setting information regarding the network between a first virtual machine and a second virtual machine, the first virtual machine working on a first information processing apparatus, the second virtual machine working on a second information processing apparatus, each of the pieces of setting information being obtained from the first information processing apparatus and the second information processing apparatus, the first setting information indicating a setting of a forward communication of a round trip between the first virtual machine and the second virtual machine, the forward communication being a communication from the first virtual machine to the second virtual machine, the first setting information having been obtained from the first information processing apparatus, retrieving, from the storage device, second setting information based on the identification information, the second setting information indicating a setting of a backward communication of the round trip, the backward communication being a communication from the second virtual machine to the first virtual machine in response to the forward communication, the second setting information having been obtained from the first information processing apparatus, when the second setting information indicates that a communication between the first virtual machine and the second virtual machine is not established, retrieving third setting information and fourth setting information based on the first setting information, the third setting information indicating a setting of the forward communication and having been obtained from the second information processing apparatus, the fourth setting information indicating a setting of the backward communication and having been obtained from the second information processing apparatus, and specifying a failure location regarding the round trip based on a pattern indicating a communication state and a plurality of reference patterns corresponding to each of a plurality of locations that is a cause of the failure, the pattern being represented using at least one of the first setting information, the second setting information, the third setting information and the fourth setting information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the setting of an overlay network;

FIG. 2 is a functional block diagram of a failure location specification apparatus according to this embodiment;

FIG. 3 is a diagram illustrating an example of a setting information database;

FIG. 4 is a diagram illustrating round trip between a start-side virtual machine and an acceptance-side virtual machine;

FIG. 5 is a diagram illustrating an example of a retrieval state data structure;

FIG. 6 is a diagram illustrating a pattern indicating that the setting of a virtual machine is a failure location;

FIG. 7 is a diagram illustrating a pattern indicating that a user's setting of a security group of transmission and reception is a failure location;

FIG. 8 is a diagram illustrating a pattern indicating that a user's setting of routing is a failure location;

FIG. 9 is a diagram illustrating a pattern indicating a system failure of a tunnel;

FIG. 10 is a diagram illustrating the transition of a retrieval process;

FIG. 11 is a block diagram illustrating a schematic configuration of a computer functioning as the failure location specification apparatus according to this embodiment;

FIG. 12 is a flow chart illustrating an example of a failure location specification process;

FIG. 13 is a diagram illustrating an example of retrieval conditions for retrieving setting information for start-side forward path transmission;

FIG. 14 is a flow chart illustrating an example of a failure analysis process;

FIG. 15 is a flow chart illustrating an example of a failure location specification process;

FIG. 16 is a flow chart illustrating an example of a failure location specification process;

FIGS. 17A and 17B indicate a flow chart illustrating an example of a failure location specification process; and

FIG. 18 is a diagram illustrating an example of an analysis result list.

### DESCRIPTION OF EMBODIMENT

For example, in the above-described overlay network, there is a function of outputting setting information in a case of network setting as a log from each physical machine in which a virtual machine having a network set therein is constructed. In a case where a communication failure occurs, for example, an operator coping with the failure specifies a physical machine including a virtual machine having performed communication in which the failure has occurred, and acquires a log file of setting information which is output from the physical machine. The operator retrieves setting information of the communication in which the failure has occurred, based on an IP address of a virtual network used for the communication, a TCP port, and information of the virtual machine in the acquired log file. It is assumed that the operator analyzes the failure based on the retrieved setting information.

However, in a case where communication goes through a plurality of physical machines, it is desirable to acquire log files which are output from the physical machines while following the going-through of the communication and to retrieve desired setting information, which results in an increase in the number of times of retrieval of setting information which is performed to specify a failure location. In addition, in a case where data is transferred to an unintended device due to a setting error or the like, and the like, it may be difficult to retrieve setting information while following the route of the communication.

An object of an aspect of the disclosed technique is to specify a failure location with a small number of times of retrieval.

In this embodiment, a description will be given of a case where a virtual network of a virtual system provided in an infrastructure as a service (IaaS) system is dynamically set by an overlay network.

Here, an overlay network premised in this embodiment will be described before describing details of this embodiment. In the overlay network according to this embodiment, network address translation (NAT) or a load balancer for each transmission control protocol (TCP) session (unit for performing communication) is realized, and thus a network is set for each TCP session. In this embodiment, as an example, a description will be given of a case where an overlay network is set by OpenFlow (registered trademark) which is a technique based on a software defined network (SDN).

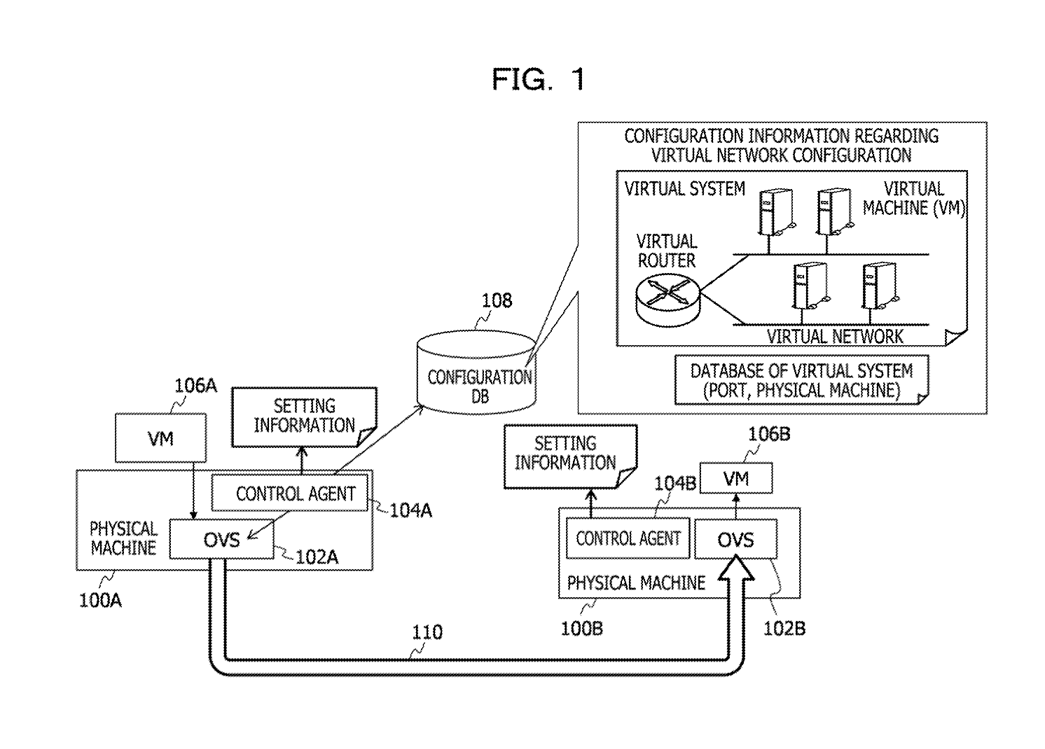

More specifically, as illustrated in FIG. 1, a description will be given of an example of the setting of an overlay network when a packet is transferred to a virtual machine 106B constructed on a physical machine 100B from a virtual machine (VM) 106A constructed on a physical machine 100A. As illustrated in FIG. 1, in OpenFlow (registered trademark), the physical machines 100A and 100B respectively include OpenVSwitches (hereinafter, simply referred to as “OVS”) 102A and 102B that perform the transfer of a packet and control agents 104A and 104B that control a transfer path of the packet. In addition, a server different from the physical machines 100A and 100B includes a configuration database (DB) 108 that stores configuration information regarding a virtual network configuration of a virtual system including a virtual machine, a virtual network, a virtual router, and the like. The configuration information also includes the position (for example, an IP address of a physical machine included in a virtual machine) of each virtual machine or correspondence information between each virtual machine and an input port number of OVS.

The OVSes 102A and 102B are pieces of software that perform processing for a packet conforming to conditions of a flow defining an action for the packet with reference to a table in which the flow is set. As the conditions, it is possible to use information, such as a combination of an input port, an Ethernet (registered trademark) header, an Internet Protocol (IP) header, and a TCP header, which is used to be capable of identifying a series of packets. In addition, as the action, it is possible to determine the output of a packet from a specific port, the transfer of a packet using a tunnel, the cancellation of a packet, the rewriting of a header, and the like. Meanwhile, the transfer of the packet using the tunnel is the transfer of the packet through the tunnel generated as a virtual line. Here, a tunnel 110 is dynamically generated between the physical machine 100A having the virtual machine 106A constructed therein and the physical machine 100B having the virtual machine 106B, which is a transfer destination of a packet, constructed therein. In addition, the rewriting of the header includes the rewriting of an L2 header and an L3 header, or a network address port translation (NApT) process.

When a packet that does not conform to the conditions of the flow which is set in the table is input from the virtual machine 106A, the OVS 102A inquires of the control agent 104A about an action for the packet. The control agent 104A acquires configuration information of a virtual system to which the virtual machine 106A having output the packet belongs, from the configuration DB 108. The control agent 104A simulates an action such as processing for the packet, the transfer of the packet, or the rewriting of a header, based on the acquired configuration information.

The control agent 104A determines an action for the packet to thereby create a flow based on simulation results, and sets a flow in the table which is referred to by the OVS 102A. The OVS 102A processes the packet in accordance with the set flow. The OVS 102A executes processing according to the flow which is set in the table without inquiring of the control agent 104A about the following packet having the same flow which is subsequently input. When a fixed time elapses after the packet having the same flow is not output from the virtual machine 106A, the control agent 104A erases the flow which is set in the table.

In addition, the control agents 104A and 104B output setting information, which is an operation log at the time of creating the flow and setting the flow in the table, from the physical machines 100A and 100B.

For example, an operator on a system provider side, or the like specifies the physical machines 100A and 100B related to communication in which a failure has occurred, in a case where a user of a virtual system inquires about a failure regarding communication, or the like. The operator acquires setting information groups which are output from the specified physical machines 100A and 100B, retrieves setting information related to the communication in which the failure has occurred, and performs analysis such as the specification of a failure location.

As described above, in a case where communication goes through a plurality of physical machines, the number of times of retrieval for retrieving desired setting information from the setting information groups acquired from the physical machines 100A and 100B is increased. In addition, there is a case where it is difficult to retrieve setting information while following the route of the communication, such as a case where a packet is transmitted to an unintended device, due to a setting error or the like.

Consequently, in this embodiment, it is possible to integrate pieces of setting information in the entire IaaS system and to retrieve the setting information of the different physical machines 100A and 100B in a unified manner. In addition, in the retrieval of the setting information, a flow which is one unit of setting for the table referred to by the OVSes 102A and 102B is used as an index. Thereby, in this embodiment, setting information regarding communication in which a failure occurs is retrieved from the entire region of the system without omission by a single method, including a case where a transfer destination of a packet has an error.

Hereinafter, an example of an embodiment according to the disclosed technique will be described in detail with reference to the accompanying drawings. Meanwhile, in this embodiment, the same components as those related to the overlay network described above with reference to FIG. 1 will be denoted by the same reference numerals and signs, and a detailed description thereof will not be repeated.

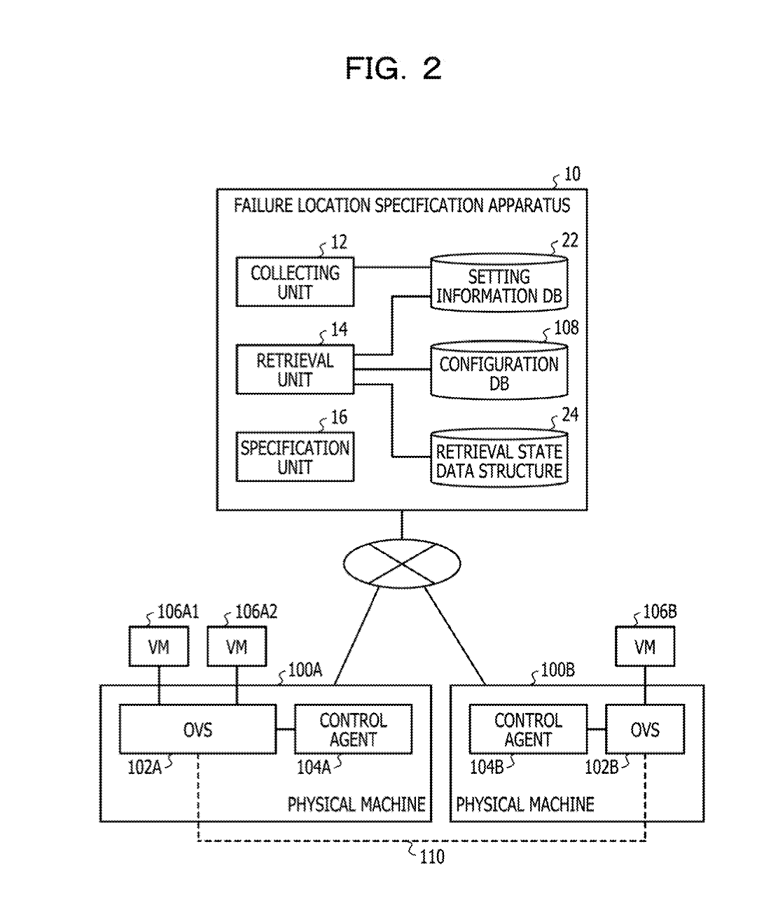

As illustrated in FIG. 2, a failure location specification apparatus 10 according to this embodiment is connected to the physical machines 100A and 100B constituting the IaaS system through a network such as the Internet. The physical machine 100A includes the OVS 102A and the control agent 104A, and the physical machine 100B includes the OVS 102B and the control agent 104B. In addition, virtual machines 106A1 and 106A2 are constructed on the physical machine 100A, and a virtual machine 106B is constructed on the physical machine 100B. Meanwhile, the control agent is an example of a control unit according to the disclosed technique, and the OVS is an example of a transfer unit of the disclosed technique.

Meanwhile, hereinafter, in a case where a description is given without distinguishing between the physical machine 100A and the physical machine 100B, A and B at the ends of signs will be omitted. Similarly, regarding the OVSes 102A and 102B, the control agents 104A and 104B, and the virtual machines 106A1, 106A2, and 106B, A, A1, A2, and B at the ends of signs will be omitted in a case where a description is given without distinction.

The failure location specification apparatus 10 functionally includes a collecting unit 12, a retrieval unit 14, and a specification unit 16. In addition, a setting information DB 22, a configuration DB 108, and a retrieval state data structure 24 are stored in a predetermined storage region of the failure location specification apparatus 10.

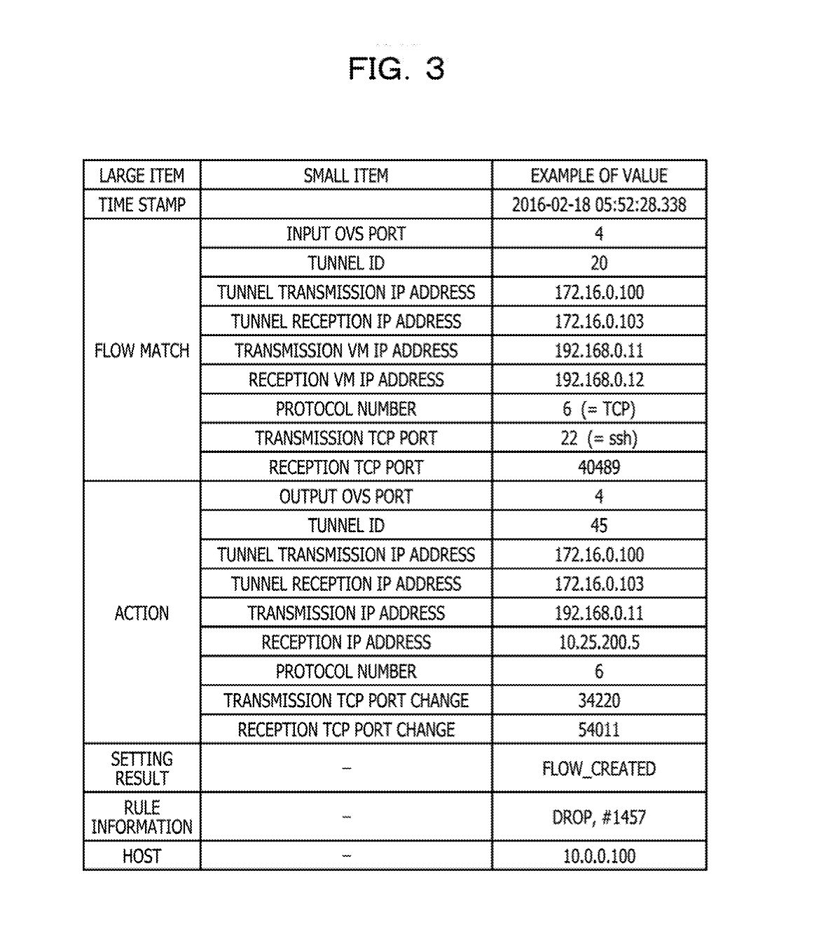

The collecting unit 12 collects pieces of setting information which are output from the respective physical machines 100, and stores the collected pieces of setting information in the setting information DB 22. Items included in the respective pieces of setting information and examples of values of the respective items are illustrated in FIG. 3. In the example of FIG. 3, “time stamp”, “flow match”, “action”, “setting result”, “rule information”, and “host” are included in each setting information as large items.

The “time stamp” is information indicating the date and time when an action for a packet according to a flow indicated by the setting information is executed.

The “flow match” is information equivalent to conditions of a flow which is set in a table referred to by the OVS 102. In the “flow match”, for example, “input OVS port” is included as a small item. The “input OVS port” is an input port number of the OVS 102 when a packet is input to the OVS 102. As described above, correspondence information between the virtual machine 106 and the input port number of the OVS 102 is stored in the configuration DB 108. The correspondence information and the “input OVS port” of the “flow match” are collated with each other, and thus it is possible to specify a packet which is input from the virtual machine 106 corresponding to a specific tenant even when users using the same IaaS are multi-tenants.

In addition, “tunnel ID”, “tunnel transmission IP address”, and “tunnel reception IP address” are included in the “flow match” as small items. The “tunnel ID” is identification information of a tunnel 110 which is used for the transfer of a packet. The “tunnel transmission IP address” and the “tunnel reception IP address” are IP addresses of the transmission-side and reception-side physical machines 100 which are connected to each other by the tunnel 110. In a case where a packet is input from the tunnel 110 to the OVS 102 by the “tunnel ID”, the “tunnel transmission IP address”, and the “tunnel reception IP address”, the tunnel 110 may be uniquely identified. Hereinafter, these three pieces of information will be also collectively referred to as “tunnel information”. In a case where the input of the packet to the OVS 102 is not an input from the tunnel 110, items of the tunnel information are left blank.

Further, in the “flow match”, so-called 5-tuple (“transmission VM IP address”, and “reception VM IP address”, “protocol number”, “transmission TCP port”, and “reception TCP port”) information for specifying a TCP session is included.

The “action” is information indicating processing contents for a packet conforming to the conditions. In the “action”, “output OVS port” is included as a small item. The “output OVS port” is an output port number when a packet is output from the OVS 102. In a case where an action executed by the OVS 102 is not an output of a packet from the port of the OVS 102, the “output OVS port” is left blank.

In addition, tunnel information (“tunnel ID”, “tunnel transmission IP address”, and “tunnel reception IP address”) of the tunnel 110 for transferring a packet are included in the “action” as small items. In a case where an action to be executed is not the transfer of a packet by the tunnel 110, items of the tunnel information are left blank.

Further, “transmission IP address change”, “reception IP address change”, “protocol number”, “transmission TCP port change”, and “reception TCP port change” are included in the “action” as small items. These items are IP addresses and port numbers after translation when NApT is executed as an action. Items in a case where NApT is not executed by an action and items which are not targets for translation are left blank.

The “setting result” is information indicating whether or not a flow has been created by the control agent 104 and has been set in a table, or information indicating whether or not another processing has been performed. In addition, “FLOW_CREATED” illustrated in FIG. 3 is an example indicating that the control agent 104 has created a flow and has set the flow in a table.

The “rule information” is information indicating whether or not a packet has been discarded, and information of a filter rule applied in a case where the packet has been discarded. In addition, “DROP,#1457” illustrated in FIG. 3 indicates that a packet has been discarded due to the application of a filter rule 1457. In addition, in a case where a packet has been accepted (in a case of no abnormality), the “rule information” is set to “ACCEPT”.

The “host” is an IP address of a physical machine that has output the corresponding setting information.

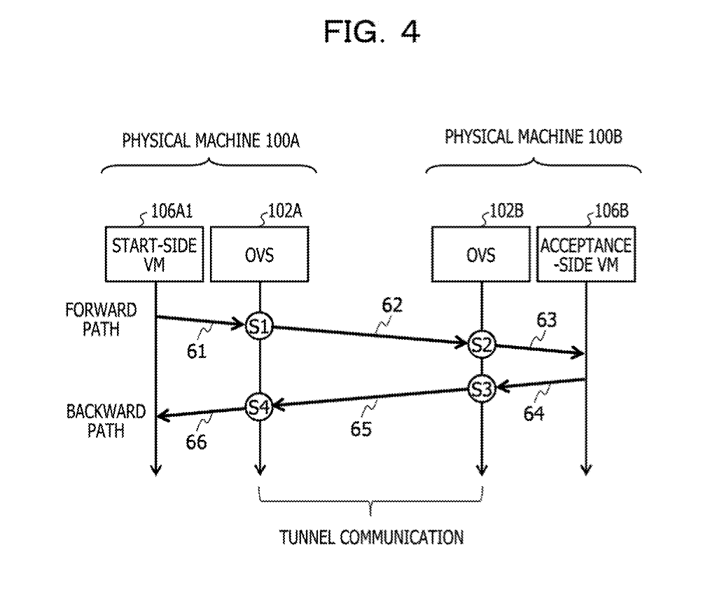

Here, as illustrated in FIG. 4, a case is considered where round trip is performed in which the virtual machine 106A1 is set to be a start side and the virtual machine 106B is set to be an acceptance side between the virtual machine 106A1 on the physical machine 100A and the virtual machine 106B on the physical machine 100B. First, in a forward path, a packet which is output from the virtual machine 106A1 is input to the OVS 102A through an input OVS port corresponding to the virtual machine 106A1 (61 in FIG. 4). The OVS 102A transmits the packet to the acceptance side by a tunnel in accordance with a flow which is created by the control agent 104A and is set in a table (62 in FIG. 4). On the acceptance side, the OVS 102B receives the packet and outputs the packet from a port corresponding to the virtual machine 106B, and the packet reaches the virtual machine 106B (63 in FIG. 4).

In a backward path, a packet which is output from the virtual machine 106B is input to the OVS 102B through an input OVS port corresponding to the virtual machine 106B (64 in FIG. 4). The OVS 102B transmits the packet to the start side by a tunnel in accordance with a flow which is created by the control agent 104B and is set in a table (65 in FIG. 4). On the start side, the OVS 102A receives the packet and outputs the packet from a port corresponding to the virtual machine 106A1, and the packet reaches the virtual machine 106A1 (66 in FIG. 4).

In this case, the flow is created and set at each of points S1, S2, S3, and S4 illustrated in FIG. 4, and the setting information thereof is output. S1 is a point at which setting information regarding a flow at the time of transmitting a packet, which is output from the start-side virtual machine 106A1, to the acceptance side is output in the forward path. S2 is a point at which setting information regarding a flow at the time of receiving a packet, which is transmitted from the start side, on the acceptance side is output in the forward path. S3 is a point at which setting information regarding a flow at the time of transmitting a packet, which is output from the acceptance-side virtual machine 106B, to the start side is output in the backward path. S4 is a point at which setting information regarding a flow at the time of receiving a packet on the start side is output in the backward path.

Hereinafter, setting information which is output at the point S1 will be referred to as “setting information for start-side forward path transmission”. In addition, setting information which is output at the point S2 will be referred to as “setting information for acceptance-side forward path reception”. In addition, setting information which is output at the point S3 will be referred to as “setting information for acceptance-side backward path transmission”. In addition, setting information which is output at the point S4 will be referred to as “setting information for start-side backward path reception”.

The retrieval unit 14 retrieves desired setting information from setting information groups which are output at the respective points by using retrieval conditions based on a point which is a target for retrieval, with reference to the setting information DB 22. The retrieval unit 14 retrieves desired setting information from setting information groups which are output at the respective points by using a 5-tuple of a packet transmitted from the start-side virtual machine 106A1 as retrieval conditions. However, since retrieval may not be accurately performed with only 5-tuple information on the start side, retrieval results of setting information which is output at another point or information of input and output OVS ports are also added in consideration of such a case.

Specifically, since an IP address may be determined for each user in a public IaaS, different users may perform TCP communication having the same IP address in a case where users of the same IaaS system are multi-tenants. In this case, in a case where only a 5-tuple is used as retrieval conditions, setting information regarding a TCP session of a different user may be retrieved in a mixed manner. Consequently, in order to retrieve setting information regarding a TCP session of a specific user, input and output OVS port numbers by which correspondence between the virtual machine 106 and the OVS 102 may be identified or tunnel information by which tunnel communication of an overlay may be uniquely identified are added to the retrieval conditions.

In addition, using different address systems inside and outside a customer system is generalized, and thus an IP address or a TCP port may be translated in the course of communication in a case where NApT is executed, or the like. In this case, even when a 5-tuple on the start side is used as retrieval conditions, it is not possible to appropriately retrieve setting information on the acceptance side. Consequently, the 5-tuple is translated based on information regarding an action included in setting information which is output at the former point, and setting information which is output at the latter point is retrieved based on the translated 5-tuple.

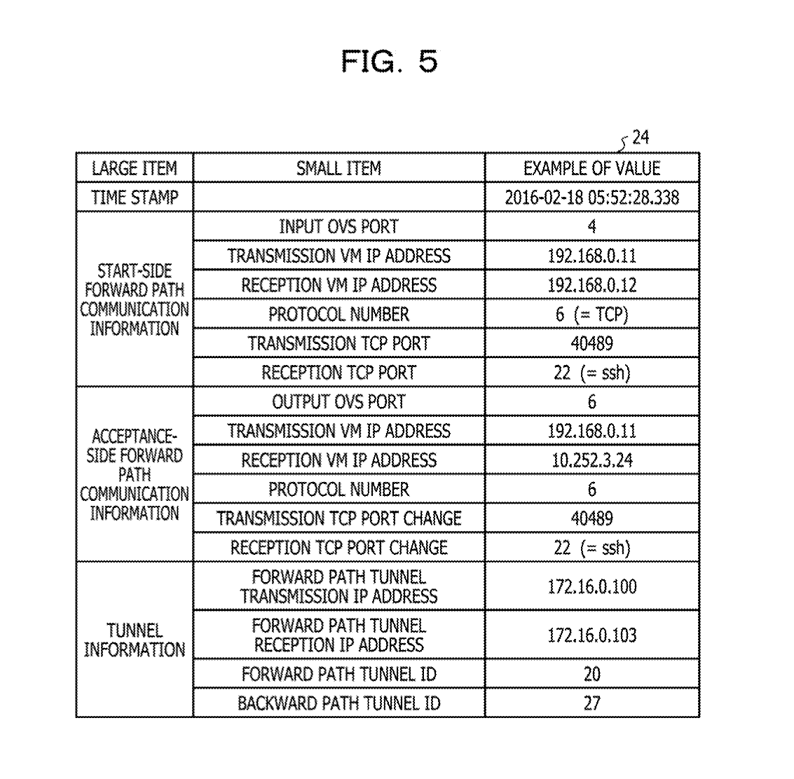

The retrieval unit 14 performs the retrieval of pieces of setting information which are output at the respective points while recording the above-mentioned information used as retrieval conditions in, for example, the retrieval state data structure 24 as illustrated in FIG. 5. In the retrieval state data structure 24, “time stamp”, “start-side forward path communication information”, “acceptance-side forward path communication information”, and “tunnel information” are included as large items. The retrieval unit 14 records information regarding items of setting information retrieved from a setting information group for start-side forward path transmission, in the item. An item having an unclear value is left blank. In addition, the retrieval unit 14 fills in a blank of the retrieval state data structure 24 based on information included in the retrieved setting information, while proceeding with the retrieval process. Further, in a case where the execution of NApT is included in an action of the retrieved setting information, the retrieval unit 14 rewrites the corresponding IP address or TCP port to a value after NApT.

The specification unit 16 specifies a failure location based on the setting information retrieved by the retrieval unit 14. In the round trip as illustrated in FIG. 4, it is possible to specify a failure location by specifying a point at which setting information conforming to retrieval conditions is not present, a point at which setting information indicating the discard of a packet is output, or the like. Specifically, the specification unit 16 specifies the failure location by comparing a pattern indicating a communication state represented by the retrieved setting information with a pattern which is defined in advance for each failure location.

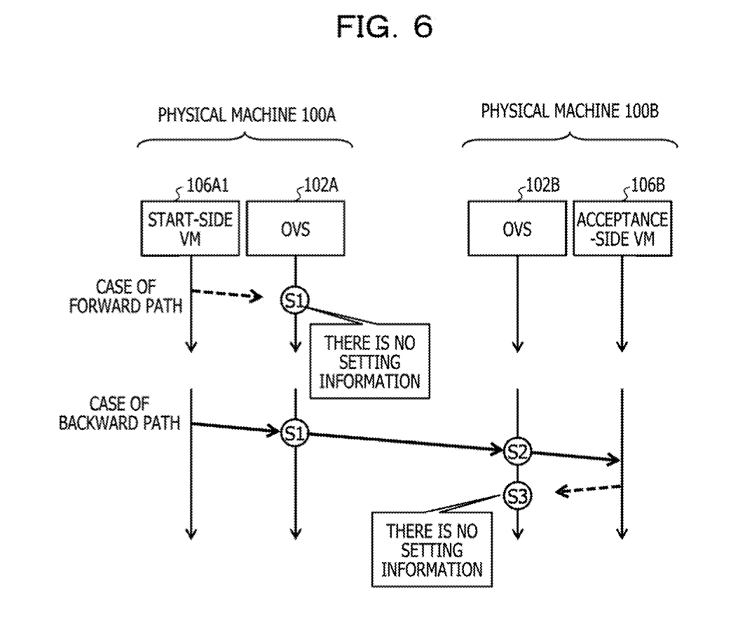

For example, a pattern of a forward path illustrated at the upper stage of FIG. 6 is a pattern in which setting information for start-side forward path transmission (S1) which conforms to retrieval conditions is not present. Similarly, a pattern of a backward path illustrated at the lower stage of FIG. 6 is a pattern in which setting information for acceptance-side backward path transmission (S3) which conforms to retrieval conditions is not present. These patterns correspond to a case where a packet drops within the virtual machine 106 and does not reach the OVS 102. In a case where a retrieval result of setting information indicates any of the patterns illustrated in FIG. 6, the specification unit 16 specifies that a user's setting of the virtual machine 106 is a failure location.

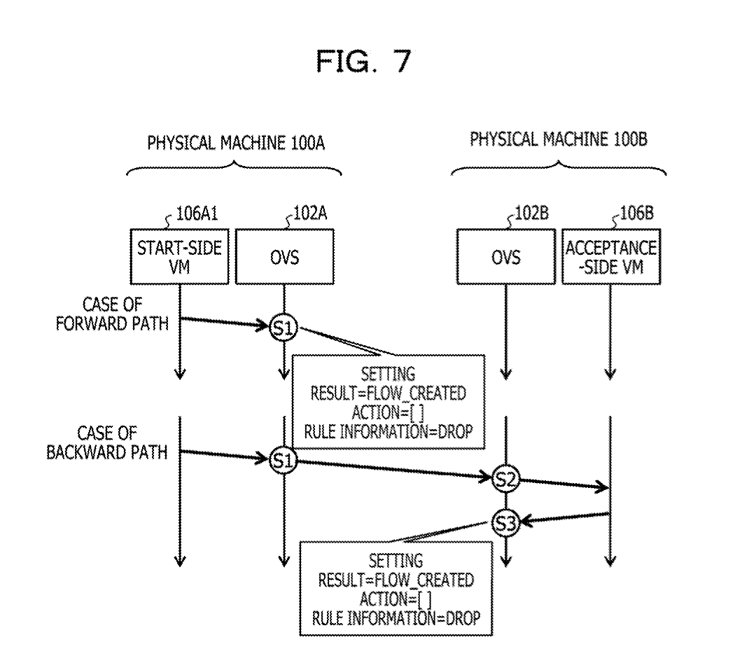

In addition, a pattern of a forward path illustrated at the upper stage of FIG. 7 is an example of a pattern in which the setting information for start-side forward path transmission (S1) which conforms to retrieval conditions indicates that a flow having the discard of a packet by a rule of security setting defined therein has been created. Similarly, a pattern of a backward path illustrated at the lower stage of FIG. 7 is an example of a pattern in which the setting information for acceptance-side backward path transmission (S3) which conforms to retrieval conditions indicates that a flow having the discard of a packet by a rule of security setting defined therein has been created. In a case where a retrieval result of setting information indicates any of the patterns illustrated in FIG. 7, the specification unit 16 specifies that a user's setting of a security group of transmission and reception is a failure location.

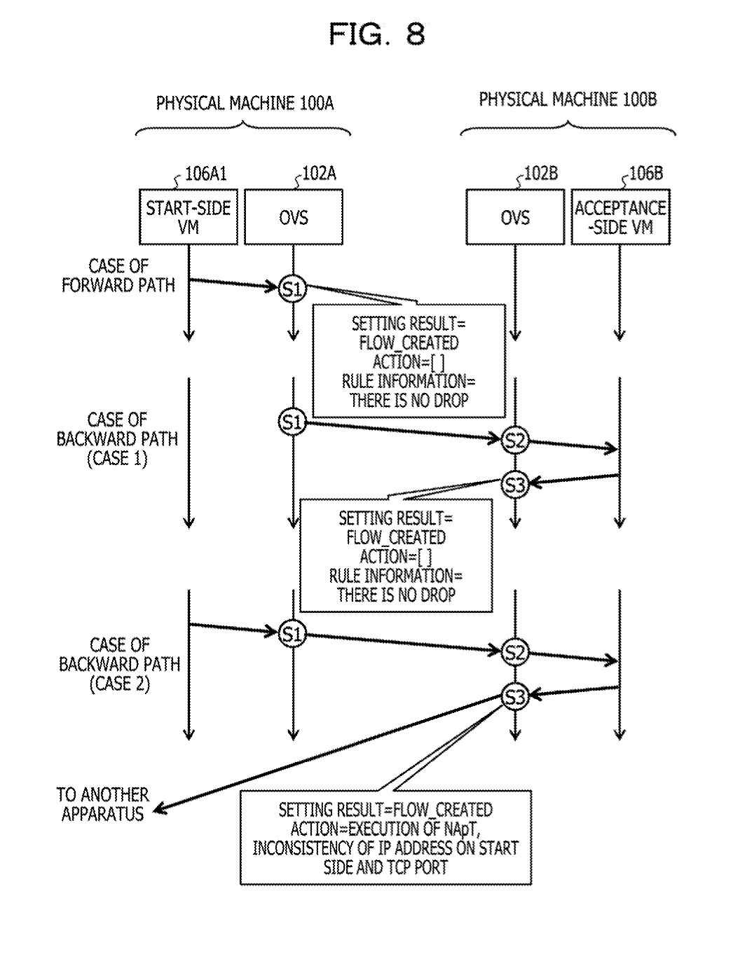

In addition, a pattern of a forward path illustrated at the upper stage of FIG. 8 is an example of a pattern in which the setting information for start-side forward path transmission (S1) which conforms to retrieval conditions indicates a case where a flow having the discard of a packet defined therein but having the reason not clearly described therein has been created. Similarly, a pattern of a backward path (case 1) illustrated at the middle stage of FIG. 8 is an example of a pattern in which the setting information for acceptance-side backward path transmission (S3) which conforms to retrieval conditions indicates a case where a flow having the discard of a packet defined therein but having the reason not clearly described therein has been created. These patterns correspond to a case where a packet is discarded without being output from the OVS 102 because there is no path toward the virtual machine 106 which is a communication destination of the packet and there is no destination of the packet. In addition, a pattern of a backward path (case 2) illustrated at the lower stage of FIG. 8 is an example of a pattern in which the setting information for acceptance-side backward path transmission (S3) which conforms to retrieval conditions indicates that a flow executing NApT has been created, but an IP address and a TCP port after translation are not consistent with a start side. This pattern corresponds to a case where communication is not realized due to the start-side virtual machine 106 being not able to receive a packet such as a case where there is an attempt to transmit a packet to the outside due to erroneous routing from the OVS 102B. Therefore, in a case where a retrieval result of setting information indicates any of the patterns illustrated in FIG. 8, the specification unit 16 specifies that a user's setting of routing is a failure location.

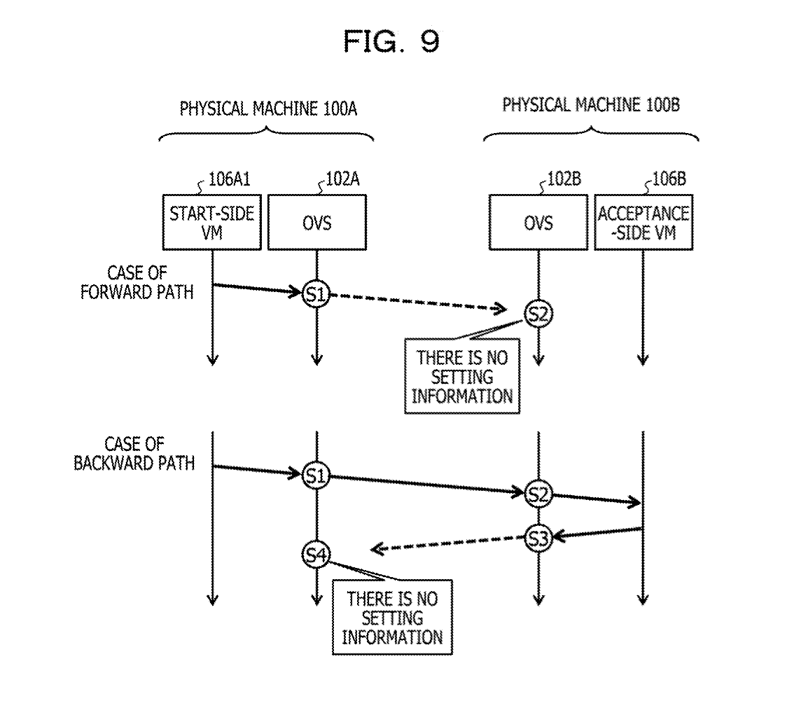

In addition, a pattern of a forward path illustrated at the upper stage of FIG. 9 is a pattern in which the setting information for start-side forward path transmission (S1) which conforms to retrieval conditions indicates that a packet is output from the OVS 102A to the virtual machine 106B, but setting information for acceptance-side forward path reception (S2) is not present. Similarly, a pattern of a backward path illustrated at the lower stage of FIG. 9 is a pattern in which the setting information for acceptance-side backward path transmission (S3) which conforms to retrieval conditions indicates that a packet is output from the OVS 102B to the virtual machine 106A1, but setting information for start-side backward path reception (S4) is not present. This pattern corresponds to a case where the output packet does not reach a communication destination in a case where there is a disconnection location in a communication path for realizing tunnel connection between the physical machine 100A and the physical machine 100B, or the like. Therefore, in a case where a retrieval result of setting information indicates any of the patterns illustrated in FIG. 9, the specification unit 16 specifies a case of a system failure of a tunnel, that is, a case of attribution to a provider side of the IaaS system.

Here, for example, in round trip between the start-side virtual machine 106A1 and the acceptance-side virtual machine 106B as illustrated in FIG. 4, it is considered that setting information is retrieved in order of the points S1, S2, S3, and S4 in order to specify the above-mentioned patterns of setting information. However, when the setting information for start-side forward path transmission which is output at the point S1 is retrieved, retrieval having the corresponding flow strictly designated therein may not be performed, for example, with only information obtained by a user's inquiry. This is because there is 5-tuple information, such as a port number which is automatically numbered, which is not recognized by the user. In this case, for example, an operator on the system provider side performs retrieval under a retrieval condition in which unclear information is set as a wild card, and thus the number of pieces of setting information conforming to retrieval conditions is increased. The operator retrieves the setting information for acceptance-side forward path reception which is output at the next point S2 based on a plurality of pieces of setting information which are retrieved from the setting information group for start-side forward path transmission. In addition, the operator sequentially retrieves the pieces of setting information which are output at the next point S3 and the subsequent point S4, based on retrieval results of setting information.

Therefore, in a case where the number of pieces of setting information conforming to retrieval conditions which are retrieved from the setting information group for start-side forward path transmission (S1) is N, a total number of times of retrieval is set to 3N+1, including one retrieval of the first setting information group for start-side forward path transmission (S1). A time taken for the retrieval process increases in proportion to the number of populations of the retrieval. In addition, in a case where N is large, a processing time taken for the entire retrieval increases.

Consequently, in this embodiment, in order to reduce the number of times of retrieval of setting information, first, a setting information group for start-side backward path reception (S4) corresponding to each of pieces of setting information conforming to retrieval conditions which are retrieved from the setting information group for start-side forward path transmission (S1) is retrieved. In a case where the setting information retrieved from the setting information group for start-side backward path reception (S4) indicates that a packet is normally output to the start-side virtual machine 106A1, it is determined that TCP session is established between the virtual machine 106A1 and the virtual machine 106B. In this case, the retrieval of the setting information for acceptance-side forward path reception (S2) and the retrieval of the setting information for acceptance-side backward path transmission (S3) are omitted.

In this case, when a presence ratio of communication having a TCP session not established therein is set to r (r<1) among the N pieces of setting information conforming to retrieval conditions which are retrieved from the setting information group for start-side forward path transmission (S1), a total number of times of retrieval is set to N(1+2r)+1. Since it is assumed that most communication is normal in the scene where a general IaaS system is used, it is considered that r is set to a very small value. Therefore, it is possible to expect a significant reduction to the number of times of retrieval which is smaller than 3N+1 which is a total number of times of retrieval in a case where the pieces of setting information which are output at the respective points are retrieved in order.

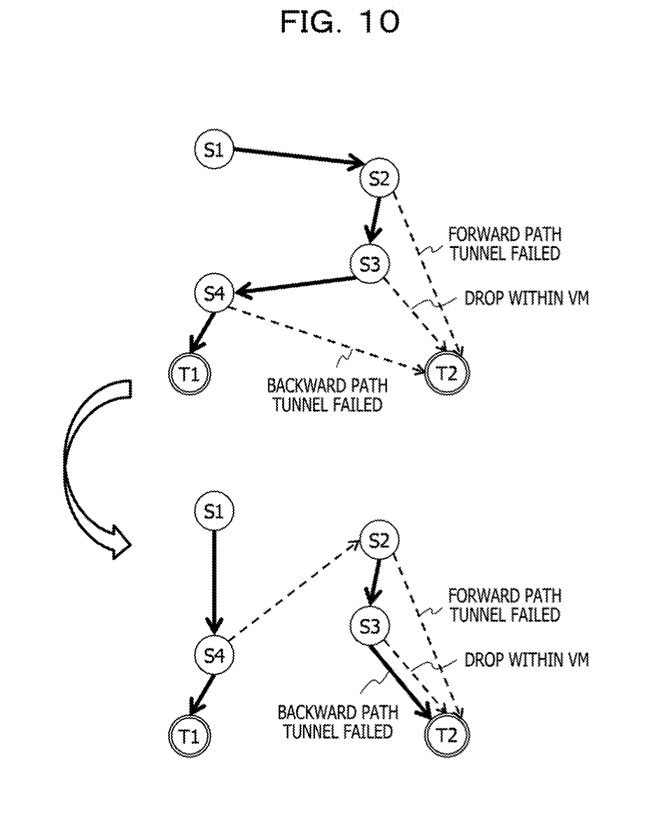

FIG. 10 is a diagram illustrating comparison between the transition of a retrieval process of retrieving pieces of setting information which are output at respective points in order and the transition of the retrieval process according to this embodiment. In FIG. 10, S1, S2, S3, and S4 are points at which setting information is output, T1 indicates a case where a TCP session is established, and T2 indicates a case where a TCP session is not established. In addition, an arrow of a solid line indicates the transition of processing in a case where setting information conforming to retrieval conditions is present at each point and a packet is normally output. An arrow of a broken line indicates the transition of processing in a case where setting information conforming to retrieval conditions is not present at each point. Meanwhile, for convenience of description, FIG. 10 does not illustrate a case where setting information conforming to retrieval conditions is not present at the point S1 and a case where setting information conforming to retrieval conditions is not present at each point, but a packet is not normally output. In a case of this embodiment (in a case of the lower diagram of FIG. 10), the number of times of retrieval to be performed by transition from S4 to S2 is small, and thus a total number of times of retrieval is reduced.

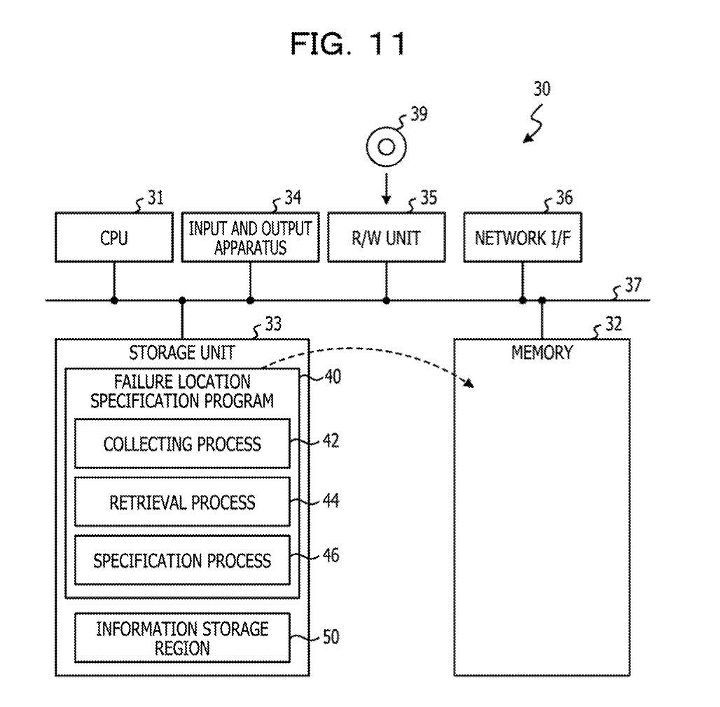

The failure location specification apparatus 10 may be realized by, a computer 30 illustrated in FIG. 11. The computer 30 includes a central processing unit (CPU) 31, a memory 32 as a transitory storage region, and a nonvolatile storage unit 33. In addition, the computer 30 includes an input and output apparatus 34, a read/write (R/W) unit 35 that controls reading and writing of data from and in a storage medium 39, and a communication interface (I/F) 36 which is connected to a network such as the Internet. The CPU 31, the memory 32, the storage unit 33, the input and output apparatus 34, the R/W unit 35, and the communication I/F 36 are connected to each other through a bus 37.

The storage unit 33 may be realized by a hard disk drive (HDD), a solid state drive (SSD), a flash memory, or the like. In the storage unit 33 as a storage medium, a failure location specification program 40 for causing the computer 30 to function as the failure location specification apparatus 10 is stored. The failure location specification program 40 includes a collecting process 42, a retrieval process 44, and a specification process 46. In addition, the storage unit 33 includes an information storage region 50 in which pieces of information constituting the setting information DB 22, the configuration DB 108, and the retrieval state data structure 24 are stored.

The CPU 31 reads out the failure location specification program 40 from the storage unit 33 and develops the read-out program into the memory 32, thereby sequentially executing the processes included in the failure location specification program 40. The CPU 31 executes the collecting process 42 to thereby function as the collecting unit 12 illustrated in FIG. 2. In addition, the CPU 31 executes the retrieval process 44 to thereby function as the retrieval unit 14 illustrated in FIG. 2. In addition, the CPU 31 executes the specification process 46 to thereby function as the specification unit 16 illustrated in FIG. 2. In addition, the CPU 31 reads out information from the information storage region 50 to thereby develop each of the setting information DB 22, the configuration DB 108, and the retrieval state data structure 24 into the memory 32. Thereby, the computer 30 having executed the failure location specification program 40 functions as the failure location specification apparatus 10.

Meanwhile, functions realized by the failure location specification program 40 may also be realized by, for example, a semiconductor integrated circuit, and more specifically, an application specific integrated circuit (ASIC), or the like.

Next, the operation of the failure location specification apparatus 10 according to this embodiment will be described.

The collecting unit 12 collects pieces of setting information which are output from the respective physical machines 100 on a regular basis and stores the collected setting information in the setting information DB 22. For example, in a case where a user of a virtual system inquires about a failure of communication, an operator on a system provider side obtains desired information from the user. Specifically, the operator obtains information for specifying the user's virtual machine, 5-tuple information of a TCP session based on the virtual machine, and information regarding a time slot in which the communication is performed. The information for specifying the user's virtual machine is, for example, identification information such as the user's tenant name, an IP address of the virtual machine 106, and the like. In a case where the user's identification information is obtained, the virtual machine is specified based on correspondence information, which is held in advance, between the user and a virtual machine which is used by the user. In addition, the 5-tuple information may include information which is not recognized by the user, and thus information in an understandable range may be obtained.

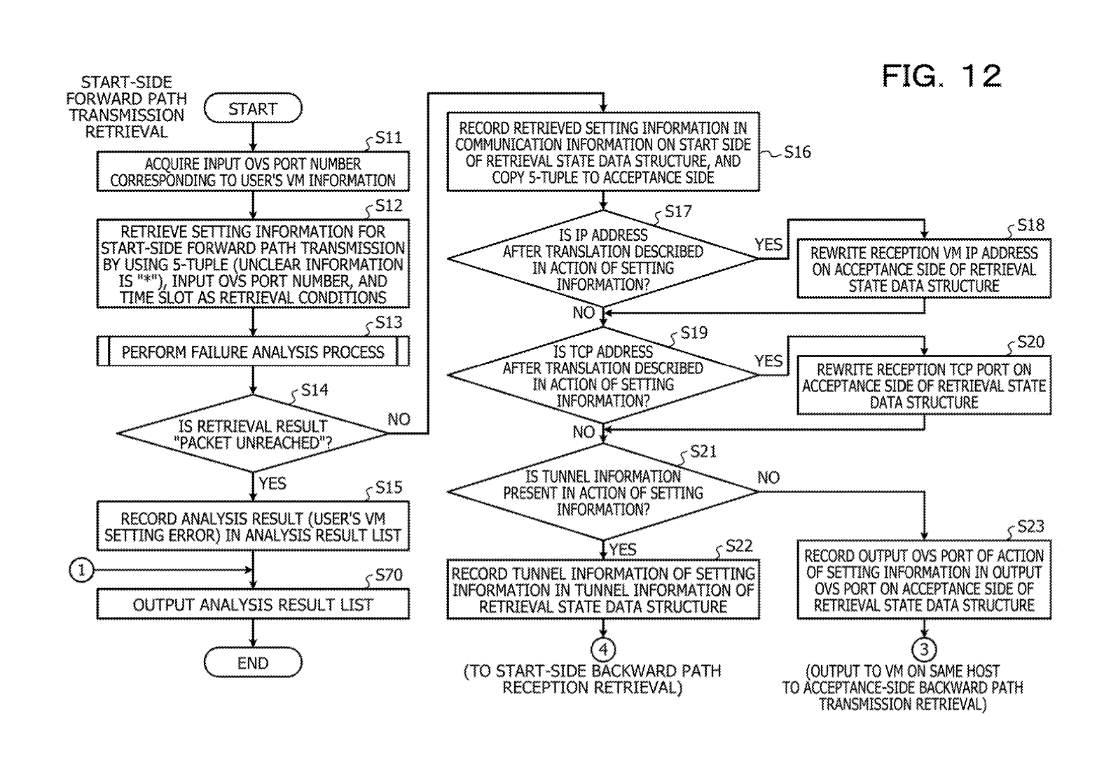

The operation on the system provider side inputs the obtained information to the failure location specification apparatus 10. Thereby, a failure location specification process is performed in the failure location specification apparatus 10. Hereinafter, the failure location specification process will be described in detail with reference to flow charts illustrated in FIG. 12 and FIGS. 14 to 17.

In step S11 of FIG. 12, the retrieval unit 14 acquires an input OVS port number of a user's virtual machine 106 with reference to correspondence information between a virtual machine stored in the configuration DB 108 and an input port number of an OVS, based on information for specifying a user's virtual machine which is input.

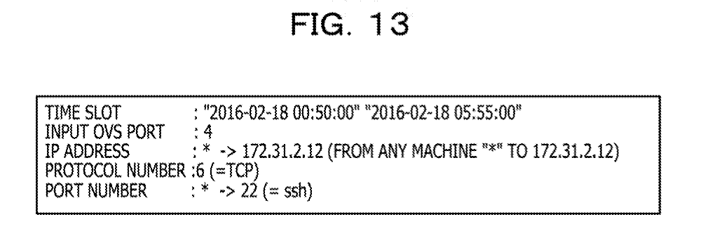

Next, in step S12, the retrieval unit 14 generates retrieval conditions from 5-tuple information and a time slot which are input and the acquired input OVS port number. Meanwhile, unclear information in the 5-tuple is set to be a wild card (*). FIG. 13 illustrates an example of retrieval conditions. In the example of FIG. 13, a transmission IP address and a transmission port number are set to be wild cards (*) because the transmission IP address and the transmission port number are unclear from obtained information. The retrieval unit 14 retrieves setting information conforming to retrieval conditions from the setting information group for start-side forward path transmission (S1) which is stored in the setting information DB 22, based on the generated retrieval conditions.

Next, in step S13, a failure analysis process is performed, and thus it is analyzed whether or not a pattern indicated by a retrieval result of setting information in step S12 described above corresponds to any of the patterns (FIGS. 6 to 9) defined in advance for each failure location.

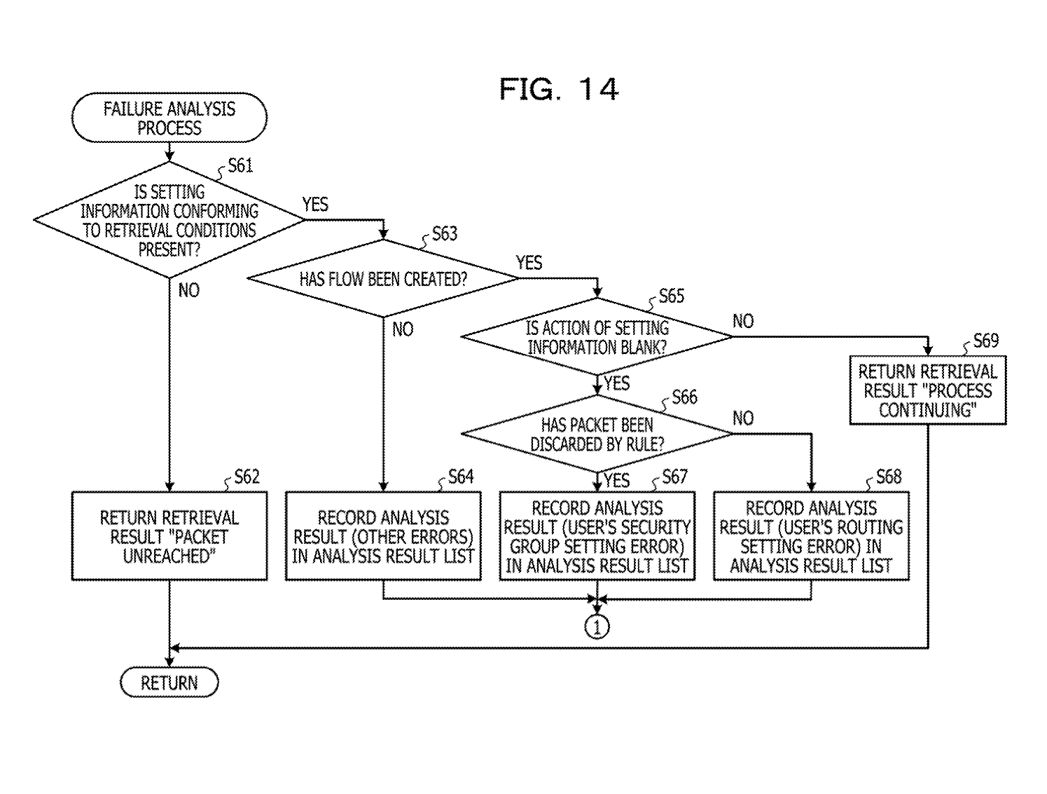

Here, a failure analysis process will be described with reference to FIG. 14.

In step S61, the specification unit 16 determines whether or not setting information conforming to the retrieval conditions created in step S12 has been retrieved from the setting information group for start-side forward path transmission (S1). In a case where setting information conforming to the retrieval conditions is not present, the process proceeds to step S62. In step S62, the specification unit 16 returns a retrieval result “packet unreached” indicating that a packet has not reach the OVS 102A to a call side of the failure analysis process. On the other hand, in a case where setting information conforming to the retrieval conditions is present, the process proceeds to step S63. Meanwhile, in a case where a plurality of pieces of setting information conforming to the retrieval conditions are present, the process of step S63 and the subsequent processes are performed on each of the plurality of pieces of setting information.

In step S63, the specification unit 16 determines whether or not a flow has been created, with reference to the item of the “setting result” of the retrieved setting information. In a case where a flow has not been created, the process proceeds to step S64, and thus the specification unit 16 records an analysis result to the effect that a failure other than a failure location indicated by the pattern defined in advance occurs, in an analysis result list (details thereof will be described later).

On the other hand, in a case where a flow has been created, the process proceeds to step S65, and thus the specification unit 16 determines whether or not the item of the “action” of the retrieved setting information is blank. In a case where the item of the “action” is blank, the specification unit 16 determines whether or not a flow having the discard of a packet by a rule of security setting defined therein has been created, with reference to the item of the “rule information” in the next step S66. In a case of affirmative determination, the specification unit 16 specifies in step S67 that the pattern indicated by the retrieved setting information corresponds to the pattern illustrated in the upper diagram of FIG. 7, that is, a user's setting of a security group is a failure location. The specification unit 16 records the specified analysis result in the analysis result list.

On the other hand, in a case where negative determination is made in step S66, the process proceeds to step S68, and thus the specification unit 16 specifies that the pattern indicated by the retrieved setting information corresponds to the pattern illustrated in the upper diagram of FIG. 8, that is, a user's setting of routing is a failure location. The specification unit 16 records the specified analysis result in the analysis result list.

In addition, in a case where it is determined in step S65 described above that the item of the “action” of the retrieved setting information is not blank, the process proceeds to step S69, and thus the specification unit 16 returns a retrieval result “process continuing” to the call side of the failure analysis process.

Referring back to FIG. 12, in the next step S14, the specification unit 16 determines whether or not the retrieval result returned in step S13 described above is “packet unreached”. The process proceeds to step S15 in a case where the retrieval result is “packet unreached”. The process proceeds to step S16 in a case where the retrieval result is “process continuing”. Meanwhile, in a case where a plurality pieces of setting information conforming to the retrieval conditions created in step S12 are present, the process of step S16 and the subsequent processes are performed on each of the plurality of pieces of setting information.

In step S15, the specification unit 16 specifies that the pattern indicated by the retrieved setting information corresponds to the pattern illustrated in the upper diagram of FIG. 6, that is, a user's setting of a virtual machine is a failure location, based on the retrieval result of “packet unreached”. The specification unit 16 records the specified analysis result in the analysis result list.

On the other hand, in step S16, the retrieval unit 14 records pieces of information regarding the items of the setting information retrieved from the setting information group for start-side forward path transmission (S1) in step S12 described above, in the corresponding items of the “time stamp” and the “start-side forward path communication information” of the retrieval state data structure 24. In addition, the retrieval unit 14 copies 5-tuple information recorded in “start-side forward path communication information” of the retrieval state data structure 24 to “acceptance-side forward path communication information”.

Next, in step S17, the retrieval unit 14 determines whether or not an IP address after translation is described in the item of the “reception IP address change” of the “action” of the setting information retrieved in step S12 described above. In a case where the IP address after translation is described, the process proceeds to step S18. In step S18, the retrieval unit 14 rewrites the item of the “reception VM IP address” of the “acceptance-side forward path communication information” of the retrieval state data structure 24 to the IP address after translation, and the process proceeds to step S19. In a case where the item of the “reception IP address change” of the “action” is blank, the process proceeds to step S19 as it is.

In step S19, the retrieval unit 14 determines whether or not a TCP port after translation is described in the item of the “reception TCP port change” of the “action” of the retrieved setting information. In a case where the TCP port after translation is described, the process proceeds to step S20. In step S20, the retrieval unit 14 rewrites the item of the “reception TCP port” of the “acceptance-side forward path communication information” of the retrieval state data structure 24 to the TCP port after translation, and the process proceeds to step S21. In a case where the item of the “reception TCP port change” of the “action” is blank, the process proceeds to step S21 as it is.

In step S21, the retrieval unit 14 determines whether or not tunnel information (“tunnel ID”, “tunnel transmission IP address”, and “tunnel reception IP address”) is described in the “action” of the retrieved setting information. In a case where the tunnel information is described, the process proceeds to step S22.

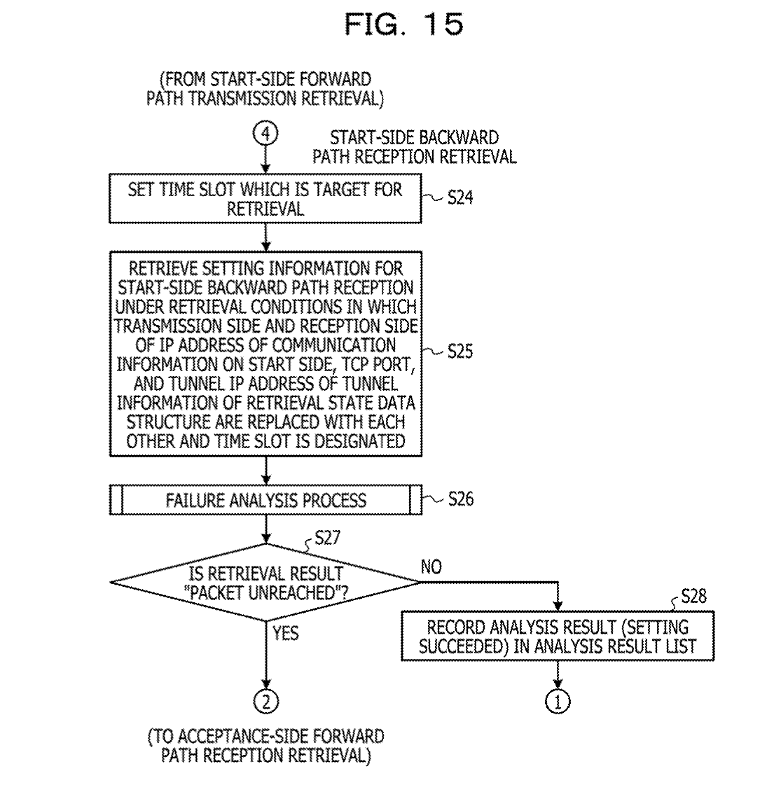

In step S22, the retrieval unit 14 records the items of the tunnel information of the “action” of the retrieved setting information in the “forward path tunnel transmission IP address”, the “forward path tunnel reception IP address”, and the “forward path tunnel ID” of the “tunnel information” of the retrieval state data structure 24. Subsequently, the process proceeds to step S24 of FIG. 15 in order to perform a retrieval process for the setting information group for start-side backward path reception (S4). This is equivalent to the transition of the retrieval process from S1 to S4 illustrated in the lower diagram of FIG. 10.

On the other hand, in a case where it is determined in step S21 that the tunnel information is not described, it is indicated that a packet is output from an output port of the OVS 102 to the virtual machine 106 rather than being output from a tunnel. That is, communication between virtual machines on the same host is indicated. For example, as illustrated in FIG. 2, communication between the virtual machine 106A1 and the virtual machine 106A2 which are connected to one OVS 102A functioning as a hypervisor (not illustrated) of the physical machine 100A is communication between virtual machines on the same host. In a case of the transfer of a packet from the virtual machine 106A1 to the virtual machine 106A2, the OVS 102A executes an action of outputting a packet from an output OVS port corresponding to the virtual machine 106A2.

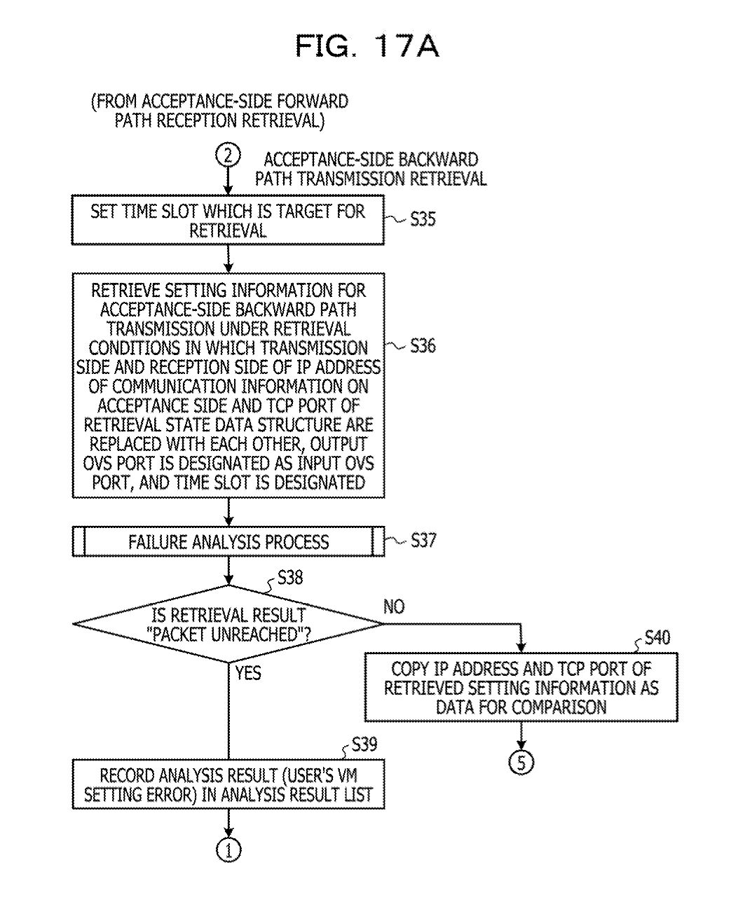

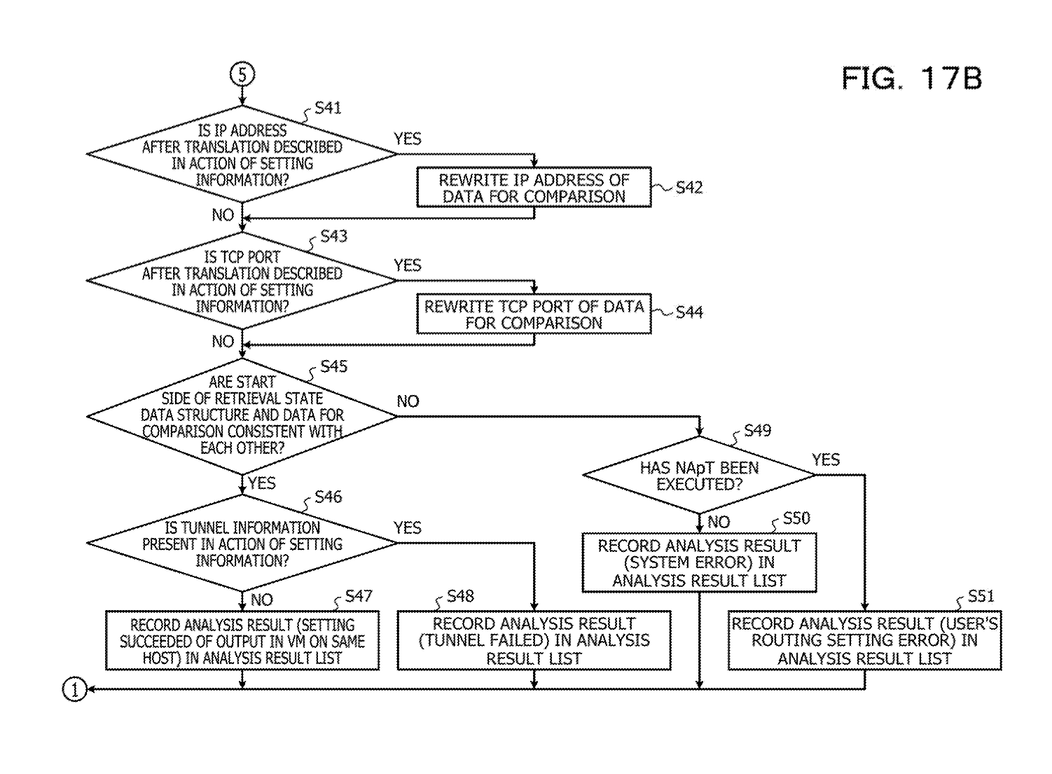

Consequently, in the next step S23, the retrieval unit 14 records a port number of the OVS 102A which is described in the “output OVS port” of the “action” of the retrieved setting information in the “output OVS port” of the “acceptance-side forward path communication information” of the retrieval state data structure 24. Subsequently, the process proceeds to step S35 of FIG. 17A in order to perform a retrieval process for setting information group for acceptance-side backward path transmission (equivalent to S3) in the communication between virtual machines on the same host.

In the step S24 of FIG. 15, the retrieval unit 14 sets a time slot which is a target for retrieval when setting information conforming to retrieval conditions is retrieved from the setting information group for start-side backward path reception (S4). The retrieval unit 14 sets the time slot which is a target for retrieval in consideration of a time taken for round trip between the start-side virtual machine 106A1 and the acceptance-side virtual machine 106B. For example, 128 seconds which is a default value of a syn packet response waiting time-out time of a TCP session in Linux (registered trademark) is used.

Specifically, the retrieval unit 14 may set a range between a time recorded in the “time stamp” of the retrieval state data structure 24 and a time after 128 seconds as a time slot which is a target for retrieval. Meanwhile, the time recorded in the “time stamp” of the retrieval state data structure 24 is a value of the “time stamp” of the setting information retrieved from the setting information group for start-side forward path transmission (S1), and is equivalent to a time when a packet is output from the OVS 102A on the start side.

Next, in step S25, the retrieval unit 14 generates retrieval conditions from the items of the “start-side forward path communication information” and the “tunnel information” of the retrieval state data structure 24 and the time slot which is set in step S24 described above. Specifically, the retrieval unit 14 generates IP addresses obtained by replacing transmission and reception sides of the “transmission VM IP address” and the “reception VM IP address” of the “start-side forward path communication information” with each other and TCP port numbers obtained by replacing transmission and reception sides of the “transmission TCP port” and the “reception TCP port” with each other, as retrieval conditions. In addition, the retrieval unit 14 adds tunnel IP addresses obtained by replacing transmission and reception sides of the “forward path tunnel transmission IP address” and the “forward path tunnel reception IP address” of the “tunnel information” with each other to the retrieval conditions. The retrieval unit 14 adds information regarding the time slot which is set in step S24 described above to the retrieval conditions. The retrieval unit 14 retrieves setting information conforming to the retrieval conditions from the setting information group for start-side backward path reception (S4) which is stored in the setting information DB 22, based on the generated retrieval conditions.

Next, a failure analysis process (FIG. 14) is performed in step S26, similar to step S13 described above. Thereby, it is analyzed whether or not a pattern indicated by a retrieval result of setting information in step S25 described above corresponds to any of the patterns (FIGS. 6 to 9) defined in advance for each failure location.

Meanwhile, in a case where the discard of a packet on the reception side is ascertained as a simulation result when the control agent 104 creates a flow, a flow for discarding the packet on the transmission side without sending the packet to a network is created. Therefore, in the failure analysis process performed in step S26, it is assumed that there are no cases corresponding to a pattern for leading step S65 to affirmative determination and a pattern for leading step S66 to negative determination.

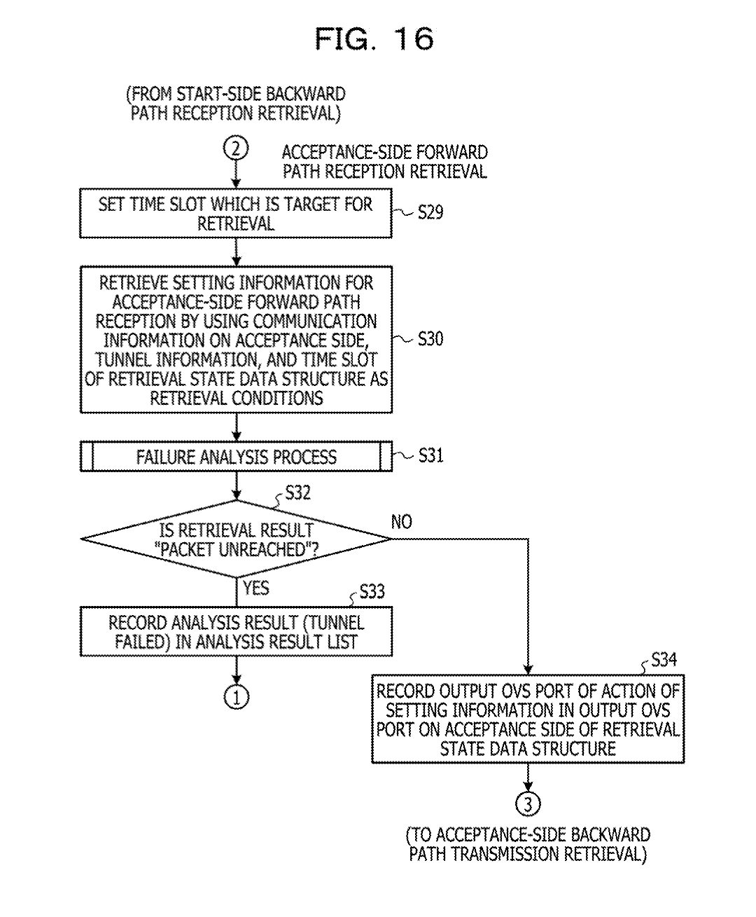

Referring back to FIG. 15, in the next step S27, the specification unit 16 determines whether or not the retrieval result returned in step S26 described above is “packet unreached”. In a case where the retrieval result is “packet unreached”, it is indicated that a TCP session has not been established, and thus the process proceeds to step S29 of FIG. 16 in order to subsequently perform a retrieval process for the setting information for acceptance-side forward path reception (S2). This is equivalent to the transition of the retrieval process from S4 to S2 illustrated in the lower diagram of FIG. 10.

On the other hand, in a case where the retrieval result is “process continuing”, it is indicated that a TCP session has been established. Accordingly, the process proceeds to step S28, and thus the specification unit 16 records an analysis result “setting succeeded” in the analysis result list.

Next, in step S29 of FIG. 16, the retrieval unit 14 sets a time slot which is a target for retrieval, similar to step S24 described above (FIG. 15).

Next, in step S30, the retrieval unit 14 generates retrieval conditions from the items of the “acceptance-side forward path communication information” and the “tunnel information” of the retrieval state data structure 24 and the time slot which is set in step S29 described above. In steps S17 to S20 described above (FIG. 12), the translation of an IP address and a TCP port based on NApT is reflected on the “acceptance-side forward path communication information” of the retrieval state data structure 24. In addition, in steps S21 and S22 described above (FIG. 12), the “tunnel information” of the retrieval state data structure 24 is also recorded. Therefore, it is possible to use information regarding the items of the “acceptance-side forward path communication information” and the “tunnel information” of the retrieval state data structure 24 as retrieval conditions of the setting information for acceptance-side forward path reception (S2). The retrieval unit 14 retrieves setting information conforming to the retrieval conditions from the setting information for acceptance-side forward path reception group (S2) which is stored in the setting information DB 22, based on the generated retrieval conditions.

Next, a failure analysis process (FIG. 14) is performed in step S31, similar to step S13 described above. Thereby, it is analyzed whether or not a pattern indicated by a retrieval result of setting information in step S30 described above corresponds to any of the patterns (FIGS. 6 to 9) defined in advance for each failure location. In the failure analysis process performed in step S31, it is assumed that there are no cases corresponding to a pattern for leading step S65 to affirmative determination and a pattern for leading step S66 to negative determination, similar to a case of the failure analysis process performed in step S26.

Referring back to FIG. 16, in the next step S32, the specification unit 16 determines whether or not the retrieval result returned in step S31 described above is “packet unreached”. The process proceeds to step S33 in a case where the retrieval result is “packet unreached”, and the process proceeds to step S34 in a case where the retrieval result is “process continuing”.

In step S33, the specification unit 16 specifies that the pattern indicated by the retrieved setting information corresponds to the pattern illustrated in the upper diagram of FIG. 9, that is, the pattern indicates a system failure of a tunnel, based on the retrieval result of “packet unreached”. The specification unit 16 records the specified analysis result in the analysis result list.

On the other hand, in step S34, the retrieval unit 14 records the port number of the OVS which is described in the “output OVS port” of the “action” of the setting information retrieved in step S30 described above in the “output OVS port” of the “acceptance-side forward path communication information” of the retrieval state data structure 24. Subsequently, the process proceeds to step S35 of FIG. 17A in order to perform a retrieval process for the setting information group for acceptance-side backward path transmission (S3).

Next, in step S35 of FIG. 17A, the retrieval unit 14 sets a time slot which is a target for retrieval, similar to step S24 described above (FIG. 15).

Next, in step S36, the retrieval unit 14 generates retrieval conditions from the items of the “acceptance-side forward path communication information” and the “tunnel information” of the retrieval state data structure 24 and the time slot which is set in step S35 described above. Specifically, the retrieval unit 14 generates IP addresses obtained by replacing transmission and reception sides of the “transmission VM IP address” and the “reception VM IP address” of the “acceptance-side forward path communication information” with each other and TCP port numbers obtained by replacing transmission and reception sides of the “transmission TCP port” and the “reception TCP port” with each other, as retrieval conditions. In addition, the retrieval unit 14 adds tunnel IP addresses obtained by replacing transmission and reception sides of the “forward path tunnel transmission IP address” and the “forward path tunnel reception IP address” of the “tunnel information” to the retrieval conditions. Further, the retrieval unit 14 adds the port number recorded in the “output OVS port” to the retrieval conditions as an input OVS port number. The retrieval unit 14 adds information regarding the time slot which is set in step S35 described above to the retrieval conditions. The retrieval unit 14 retrieves setting information conforming to the retrieval conditions from the setting information group for acceptance-side backward path transmission (S3) which is stored in the setting information DB 22, based on the generated retrieval conditions.

Next, a failure analysis process (FIG. 14) is performed in step S37, similar to step S13 described above. Thereby, it is analyzed whether or not a pattern indicated by a retrieval result of setting information in step S36 described above corresponds to any of the patterns (FIGS. 6 to 9) defined in advance for each failure location.

In the failure analysis process performed in step S37, the specification unit 16 specifies in step S67 that the pattern indicated by the retrieved setting information corresponds to the pattern illustrated in the lower diagram of FIG. 7 in a case where affirmative determination is made in steps S65 and S66. That is, it is specified that a user's setting of a security group is a failure location. The specification unit 16 records the specified analysis result in the analysis result list.

In addition, in a case where negative determination is made in step S66, the specification unit 16 specifies in step S68 that the pattern indicated by the retrieved setting information corresponds to the pattern illustrated at the middle stage of FIG. 8, that is, a user's setting of routing is a failure location. The specification unit 16 records the specified analysis result in the analysis result list.

Referring back to FIG. 17A, in the next step S38, the specification unit 16 determines whether or not the retrieval result returned in step S37 described above is “packet unreached”. The process proceeds to step S39 in a case where the retrieval result is “packet unreached”, and the process proceeds to step S40 in a case where the retrieval result is “process continuing”.

In step S39, the specification unit 16 specifies that the pattern indicated by the retrieved setting information corresponds to the pattern illustrated in the lower diagram of FIG. 6, that is, a user's setting of a virtual machine is a failure location, based on the retrieval result of “packet unreached”. The specification unit 16 records the specified analysis result in the analysis result list.

On the other hand, in step S40, the specification unit 16 copies information of “reception VM IP address” and “reception TCP port” of “flow match” of the setting information retrieved in step S36 described above as data for comparison.

Next, in step S41, the specification unit 16 determines whether or not an IP address after translation is described in an item of “reception IP address change” of “action” of the setting information retrieved in step S36 described above. In a case where the IP address after translation is described, the process proceeds to step S42. In step S42, the specification unit 16 rewrites the item of the “reception VM IP address” which is data for comparison to an IP address after translation, and the process proceeds to step S43. In a case where the item of the “reception IP address change” of the “action” is blank, the process proceeds to step S43 as it is.

In step S43, the specification unit 16 determines whether or not a TCP port after translation is described in an item of “reception TCP port change” of the “action” of the setting information retrieved in step S36 described above. In a case where the TCP port after translation is described, the process proceeds to step S44. In step S44, the specification unit 16 rewrites the item of the “reception TCP port” which is data for comparison to a TCP port after translation, and the process proceeds to step S45. In a case where the item of the “reception TCP port change” of the “action” is blank, the process proceeds to step S45 as it is.

In step S45, the specification unit 16 determines whether or not a communication destination of a packet transmitted from the acceptance-side virtual machine 106B (or the virtual machine 106A2) is the start-side virtual machine 106A1. Specifically, the specification unit 16 determines whether or not the “transmission VM IP address” of the “start-side forward path communication information” of the retrieval state data structure 24 and the “reception VM IP address” which is data for comparison are consistent with each other. In addition, the specification unit 16 determines whether or not the “transmission TCP port” of the “start-side forward path communication information” of the retrieval state data structure 24 and the “reception TCP port” which is data for comparison are consistent with each other. In a case of consistency of both an IP address and a TCP port, affirmative determination is made, and the process proceeds to step S46. In a case of inconsistency of either, negative determination is made, and the process proceeds to step S49.

In step S46, the specification unit 16 determines whether or not tunnel information is described in the “action” of the setting information retrieved in step S36 described above. The process proceeds to step S47 in a case where tunnel information is not described, and the process proceeds to step S48 in a case where tunnel information is described.

In step S47, the specification unit 16 determines communication between the virtual machines 106A1 and 106A2 on the same host because a packet is not transferred by tunnel communication. The specification unit 16 determines that a TCP session has been established based on determination results at the respective steps until step S47, and records an analysis result “setting succeeded” in the analysis result list.

On the other hand, a case where the process proceeds to step S48 is a case where a packet is correctly output to the start-side virtual machine 106A1 from the OVS 102B on the acceptance side, but a TCP session has not been established from a retrieval result of the setting information for start-side backward path reception (S4). Therefore, the specification unit 16 specifies that the pattern indicated by the retrieved setting information corresponds to the pattern illustrated in the lower diagram of FIG. 9, that is, the pattern indicates a system failure of a tunnel. The specification unit 16 records the specified analysis result in the analysis result list.

In addition, in step S49, the specification unit 16 determines whether or not inconsistency of an IP address and a TCP port between the acceptance side and the start side is caused by the execution of NApT. This determination may be performed based on the item of the “action” of the setting information retrieved in step S36. In a case where NApT is not executed, the process proceeds to step S50, and the specification unit 16 records a system error, such as an error included in the configuration information stored in the configuration DB 108, in the analysis result list as an analysis result.

In a case where NApT is executed, the process proceeds to step S51, and the specification unit 16 specifies that the pattern indicated by the retrieved setting information corresponds to the pattern illustrated in the lower diagram of FIG. 8, that is, a user's setting of routing is a failure location. The specification unit 16 records the specified analysis result in the analysis result list.

In step S12 described above, when an analysis result is recorded in the analysis result list with respect to all of the pieces of setting information retrieved from the setting information group for start-side forward path transmission (S1), the process proceeds to step S70 (FIG. 12). This is a case where an analysis result is recorded in the analysis result list in any of steps S64, S67, S68, S28, S33, S39, S47, S48, S50, and S51 described above with respect to each setting information. In addition, in a case where setting information conforming to retrieval conditions is not retrieved from the setting information group for start-side forward path transmission (S1), the process proceeds to step S70 via step S15.

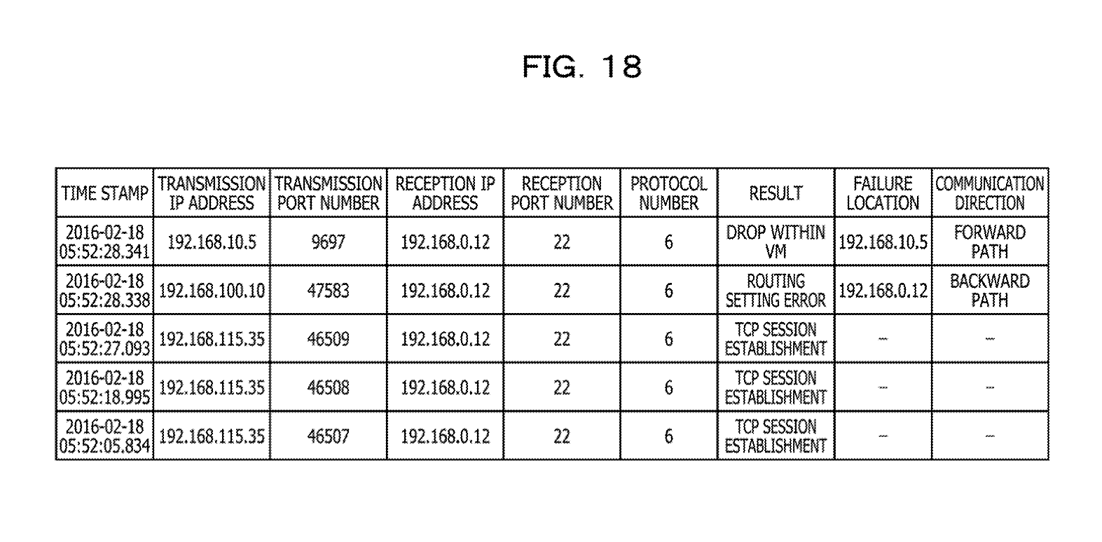

In step S70, the specification unit 16 outputs an analysis result list as illustrated in, for example, FIG. 18. In the example of FIG. 18, records (rows) are equivalent to analysis results for one piece of setting information retrieved from the setting information group for start-side forward path transmission (S1). Here, “time stamp” and 5-tuple information are information described in “flow match” of the retrieved setting information. In addition, “result”, “failure location”, and “communication direction” are information indicating to which pattern (FIGS. 6 to 9) defined in advance for each failure location a pattern indicated by the setting information corresponds. Meanwhile, the pattern indicated by the setting information is a pattern indicated by setting information retrieved from a setting information group for start-side forward path transmission and setting information retrieved from setting information groups for start-side backward path reception, acceptance-side forward path reception, and acceptance-side backward path transmission based on the setting information.

For example, in a case of the pattern illustrated in the upper diagram of FIG. 6, “result” indicates the drop of a packet within a virtual machine, “failure location” indicates information (an IP address in the example of FIG. 18) for specifying the start-side virtual machine 106A1, and “communication direction” indicates “forward path”. In addition, for example, in a case of the pattern illustrated in the middle diagram or the lower diagram of FIG. 8, “result” indicates a setting error of routing, “failure location” indicates information for specifying the acceptance-side virtual machine 106B, and “communication direction” indicates “backward path”.

When the analysis result list is output, the failure location specification process is terminated.

As described above, according to the failure location specification apparatus 10 of this embodiment, pieces of setting information of a network which are output from respective physical machines at respective points of transmission and reception of a packet are collected and are managed in a unified manner. The failure location specification apparatus 10 retrieves setting information regarding the corresponding communication from setting information groups that are output at respective points, by using information of a flow by which a series of packets may be identified. In this manner, pieces of setting information that are output from the entire system may be retrieved in a unified manner, and thus it is possible to retrieve setting information of the corresponding communication even when the transfer of a packet to an unintended device, and the like occurs.

In addition, the failure location specification apparatus 10 retrieves setting information for start-side backward path reception which corresponds to a retrieval result for start-side forward path transmission without retrieving pieces of setting information that are output at the respective points of start-side forward path transmission, acceptance-side forward path reception, acceptance-side backward path transmission, and start-side backward path reception in order of communication. Here, in a case where the retrieved setting information indicates the establishment of communication, the retrieval of setting information on the acceptance side is omitted, and thus it is possible to reduce the number of times of retrieval of setting information.

In addition, when the failure location specification apparatus 10 retrieves corresponding setting information while performing transition by using any one of setting information groups for start-side forward path transmission, start-side backward path reception, acceptance-side forward path reception, and acceptance-side backward path transmission as a target for retrieval, the failure location specification apparatus automatically creates the latter retrieval conditions by using the former retrieval results. At this time, information of a flow by which a series of packets may be identified is used as the retrieval conditions. A failure location is specified by comparison between a pattern indicated by the retrieved setting information and a pattern defined in advance for each failure location. In this manner, it is possible to specify a failure location by a single method, regardless of the cause of a failure.

As described above, the number of times of retrieval for setting information may be reduced, and thus a processing time until the specification of a failure location is reduced, thereby enabling a prompt response to a user. Specifically, in a case where it is specified that the failure location is a location based on a user's setting, a reply to the purport may be promptly given to the user. In addition, in a case where it is specified that the failure location is a system failure for which a system provider side is responsible, it is possible to transfer processing to the analysis of a more detailed cause of a failure using a known technique, such as apparatus monitoring or process monitoring, at an early stage.

Meanwhile, in the above-described embodiment, a case where an overlay network is set by OpenFlow (registered trademark) has been described, but the embodiment is not limited thereto. In a case where a network is dynamically set for each communication, the disclosed technique may be applied as long as setting information (log information) regarding the setting is output.

In the above description, a description has been given of a configuration in which the failure location specification program 40 which is an example of a program according to the disclosed technique is previously stored (installed) in the storage unit 33, but is not limited thereto. The program according to the disclosed technique may also be provided in the form of being stored in a storage medium such as a CD-ROM, a DVD-ROM, or a USB memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium storing a failure location specification program that causes a computer to execute a process, the process comprising:
retrieving first setting information from a storage device based on identification information identifying each of communications through a network, the storage device storing pieces of setting information regarding the network between a first virtual machine and a second virtual machine, the first virtual machine working on a first information processing apparatus, the second virtual machine working on a second information processing apparatus, each of the pieces of setting information being obtained from the first information processing apparatus and the second information processing apparatus, the first setting information indicating a setting of a forward communication of a round trip between the first virtual machine and the second virtual machine, the forward communication being a communication from the first virtual machine to the second virtual machine, the first setting information having been obtained from the first information processing apparatus;
retrieving, from the storage device, second setting information based on the identification information, the second setting information indicating a setting of a backward communication of the round trip, the backward communication being a communication from the second virtual machine to the first virtual machine in response to the forward communication, the second setting information having been obtained from the first information processing apparatus;
when the second setting information indicates that a communication between the first virtual machine and the second virtual machine is not established, retrieving third setting information and fourth setting information based on the first setting information, the third setting information indicating a setting of the forward communication and having been obtained from the second information processing apparatus, the fourth setting information indicating a setting of the backward communication and having been obtained from the second information processing apparatus; and
specifying a failure location regarding the round trip based on a pattern indicating a communication state and a plurality of reference patterns corresponding to each of a plurality of locations that is a cause of the failure, the pattern being represented using at least one of the first setting information, the second setting information, the third setting information and the fourth setting information.

2. The non-transitory computer-readable storage medium according to claim 1, wherein
the retrieving of the third setting information and the fourth setting information is omitted when the second setting information indicates that the communication between the first virtual machine and the second virtual machine is established.

3. The non-transitory computer-readable storage medium according to claim 1, wherein
the retrieving of the fourth setting information being performed after the retrieving of the third setting information.

4. The non-transitory computer-readable storage medium according to claim 1, wherein
each of the first setting information and the second setting information is set by a first virtual switch on the first information processing apparatus; and wherein
each of the third setting information and the fourth setting information is set by a second virtual switch on the second information processing apparatus.

5. The non-transitory computer-readable storage medium according to claim 4,
wherein the information indicating each of the communications is information regarding a TCP session and information regarding a plurality of connection ports including a first connection port and a second connection port, the first connection port being a connection port that couples the first virtual machine and the first virtual switch, the second connection port being a connection port that couples the second virtual machine and the second virtual switch.

6. The non-transitory computer-readable storage medium according to claim 1, wherein
the plurality of reference patterns includes information regarding whether or not setting information that matches a retrieval condition is present, information regarding whether or not setting information that matches the retrieval condition indicates discard of data, information regarding whether or not the discard of the data is discard based on a predetermined rule, and information regarding whether a communication destination of the data transmitted from the second virtual machine matches the first virtual machine.

7. The non-transitory computer-readable storage medium according to claim 1, wherein
the setting information includes an address of the second virtual machine and translation information of the address; and wherein
when the third setting information is retrieved based on the first setting information, the third setting information is retrieved by using a translated address into which the address included in the first setting information is translated based on the translation information.

8. The non-transitory computer-readable storage medium according to claim 1, wherein
the setting information includes identification information of a virtual communication path of the network; and wherein
when the third setting information is retrieved based on the first setting information, the identification information of the virtual communication path is added to a retrieval condition for the retrieving of the third setting information.

9. A failure location specification device comprising:
a memory; and
a processor coupled to the memory and the processor configured to:
retrieve first setting information from a storage device based on identification information identifying each of communications through a network, the storage device storing pieces of setting information regarding the network between a first virtual machine and a second virtual machine, the first virtual machine working on a first information processing apparatus, the second virtual machine working on a second information processing apparatus, each of the pieces of setting information being obtained from the first information processing apparatus and the second information processing apparatus, the first setting information indicating a setting of a forward communication of a round trip between the first virtual machine and the second virtual machine, the forward communication being a communication from the first virtual machine to the second virtual machine, the first setting information having been obtained from the first information processing apparatus;
retrieve, from the storage device, second setting information based on the identification information, the second setting information indicating a setting of a backward communication of the round trip, the backward communication being a communication from the second virtual machine to the first virtual machine in response to the forward communication, the second setting information having been obtained from the first information processing apparatus;
when the second setting information indicates that a communication between the first virtual machine and the second virtual machine is not established, retrieve third setting information and fourth setting information based on the first setting information, the third setting information indicating a setting of the forward communication and having been obtained from the second information processing apparatus, the fourth setting information indicating a setting of the backward communication and having been obtained from the second information processing apparatus; and
specify a failure location regarding the round trip based on a pattern indicating a communication state and a plurality of reference patterns corresponding to each of a plurality of locations that is a cause of the failure, the pattern being represented using at least one of the first setting information, the second setting information, the third setting information and the fourth setting information.

10. A failure location specification method executed by a computer, the failure location specification method comprising:
retrieving first setting information from a storage device based on identification information identifying each of communications through a network, the storage device storing pieces of setting information regarding the network between a first virtual machine and a second virtual machine, the first virtual machine working on a first information processing apparatus, the second virtual machine working on a second information processing apparatus, each of the pieces of setting information being obtained from the first information processing apparatus and the second information processing apparatus, the first setting information indicating a setting of a forward communication of a round trip between the first virtual machine and the second virtual machine, the forward communication being a communication from the first virtual machine to the second virtual machine, the first setting information having been obtained from the first information processing apparatus;
retrieving, from the storage device, second setting information based on the identification information, the second setting information indicating a setting of a backward communication of the round trip, the backward communication being a communication from the second virtual machine to the first virtual machine in response to the forward communication, the second setting information having been obtained from the first information processing apparatus;
when the second setting information indicates that a communication between the first virtual machine and the second virtual machine is not established, retrieving third setting information and fourth setting information based on the first setting information, the third setting information indicating a setting of the forward communication and having been obtained from the second information processing apparatus, the fourth setting information indicating a setting of the backward communication and having been obtained from the second information processing apparatus; and
specifying a failure location regarding the round trip based on a pattern indicating a communication state and a plurality of reference patterns corresponding to each of a plurality of locations that is a cause of the failure, the pattern being represented using at least one of the first setting information, the second setting information, the third setting information and the fourth setting information.
